(19) United States
(12) Patent Application Publication
(10) Pub. No.: US 2009/0292846 A1
(43) Pub. Date: Nov. 26, 2009

(54) METHOD OF INTERRUPT SCHEDULING

(76) Inventors: Kyu-Ho Park, Daejeon (KR); Ju-Pyung Lee, Suwon-si (KR)

Correspondence Address: The Belles Group, P.C., 1518 Walnut Street, Suite 1706, Philadephia, PA, 19102, US

(21) Appl. No.: 12/469,936

(22) Filed: May 21, 2009

(30) Foreign Application Priority Data
May 21, 2008 (KR) 10-2008-0047036

(51) Int. Cl. G06F 13/24; G06F 9/46

(52) U.S. Cl. 710/260; 718/108

(57) ABSTRACT

There is provided a method of interrupt scheduling. The method comprises: without allowing a target process woken up when an interrupt occurs to enter into a ready queue, directly comparing the priority of the woken-up target process with that of a current process performed before the occurrence of the interrupt, and executing a rescheduling in accordance with the compared result; and performing direct context switching with respect to the current process into the target process in accordance with whether or not the rescheduling is executed. Accordingly, in the method of interrupt scheduling, the preemption latency caused by the interrupt in the operating system of the computer system can be minimized by omitting the process of allowing the woken-up target process to enter into the ready queue and the process of selecting a process with the highest priority on the ready queue.

### CROSS-REFERENCE TO RELATED APPLICATION

This application claims priority to Korean Patent Application No. 10-2008-0047036, filed on May 21, 2008, and all the benefits accruing therefrom under 35 U.S.C. §119, the contents of which in its entirety are herein incorporated by reference.

### BACKGROUND OF INVENTION

1. Field

The present relates to a method of interrupt scheduling.

2. Description of the Related Art

In general, when an interrupt occurs in an operating system of a computer system, an interrupt handler function is called to process the interrupt. The interrupt handler function is executed in the context of a process which is being performed when the interrupt occurs. The interrupt handler function may comprise a routine which allows a target process waiting for the corresponding interrupt to wake up.

The target process woken up by the interrupt handler function is entered into a ready queue so as to be selected and immediately performed by an operating system scheduler. After the execution of the interrupt handler function is finished, the operating system scheduler selects a process with the highest priority among a series of processes on the ready queue and then allows the process to be performed. When a process performed before the occurrence of the interrupt has the highest priority, kernel is not preempted. However, when the target process woken up by the interrupt handler function has the highest priority, the process performed before the occurrence of the interrupt is preempted by the target process.

Hereinafter, a conventional method of interrupt scheduling will be described with reference to the accompanying drawing.

FIG. 1 is a flowchart schematically illustrating a conventional method of interrupt scheduling.

Referring to FIG. 1, in the conventional method of interrupt scheduling, when an interrupt occurs (101), a process which is performed currently is paused, and the execution of an interrupt handler function is started in the context of the currently performed process (103).

Subsequently, the interrupt handler function wakes up a target process in a sleep state while waiting for the corresponding interrupt (105).

Subsequently, the target process is entered into a ready queue so as to be selected at any time and immediately performed by an operating system scheduler, and waits for the selection of the operating system scheduler (107).

Subsequently, a kernel checks whether or not the priority of the target process is higher than that of the currently performed process (109). When the priority of the target process is higher than that of the currently performed process, a rescheduling is executed so that an operating system scheduler function can be called subsequently (111). After the rescheduling is executed, the execution of the interrupt handler function is finished (113). On the other hand, when the priority of the currently performed process is higher than that of the target process, the execution of the interrupt handler function is immediately finished (113).

After the execution of the interrupt handler function is finished (113), it is determined whether or not a rescheduling is executed (115). When the rescheduling is executed (111), a rescheduling is required. Therefore, the operating system scheduler function is called, thereby selecting a process with the highest priority on the ready queue (117). At this time, the target process with the highest priority may be selected among processes on the ready queue. Subsequently, the operating system scheduler function performs context switching with respect to the currently performed process into the target process (119). On the other hand, when the rescheduling is not executed, the currently performed process continuously carries out the operation which is performed before the occurrence of the interrupt (121).

Accordingly, in the conventional method of interrupt scheduling, the target process entered into the ready queue is selected as a subsequently performed process by the operating system scheduler to preempt the currently performed process, in most cases from when the target process is woken up by the interrupt handler function to when the kernel checks whether or not the priority of the target process is higher than that of the currently performed process. That is, when the target process surely preempts the currently performed process, it is unnecessary to allow the woken-up target process to enter into the ready queue and to call the operating system scheduler for processing the target process. Therefore, in the conventional method of interrupt scheduling, the preemption latency from the occurrence of the interrupt to the performance of the target process may be unnecessarily used.

### SUMMARY OF THE INVENTION

The present invention provides a method of interrupt scheduling, which minimizes the preemption latency from the occurrence of an interrupt to the performance of a target process.

The present invention also provides a computer-readable recording medium in which a program for implementing the method of interrupt scheduling is recorded.

In one aspect, there is provided a method of interrupt scheduling, which comprises: without allowing a target process woken up when an interrupt occurs to enter into a ready queue, directly comparing the priority of the woken-up target process with that of a current process performed before the occurrence of the interrupt, and executing a rescheduling in accordance with the compared result; and performing direct context switching with respect to the current process into the target process in accordance with whether or not the rescheduling is executed.

After performing the context switching, the method may further comprise: determining whether or not the current process is entered into the ready queue; and allowing an operating system scheduler to carry out an operation when the current process is entered into the ready queue, and allowing the current process to enter into the ready queue and then allowing the operating system scheduler to carry out the operation when the current process is not entered into the ready queue.

The executing of the rescheduling may comprise: determining whether or not the target process is woken up; directly comparing the priority of the woken-up target process with that of the current process when the target process is woken up; and executing a rescheduling and then finishing the execution of an interrupt handler function when the priority of the target process is higher than that of the current process, and allowing the target process to enter into the ready queue and then finishing the execution of the interrupt handler function when the priority of the target process is lower than that of the current process.

The performing of the context switching may comprise: determining whether or not the rescheduling is executed; and performing direct context switching with respect to the current process into the target process when the rescheduling is executed, and carrying out the operation of the current process when the rescheduling is not executed.

In another aspect, there is provided a method of interrupt scheduling, which comprises: without allowing a target process woken up when an interrupt occurs to enter into a ready queue, directly comparing the priority of the woken-up target process with that of a current process performed before the occurrence of the interrupt; and performing direct context switching with respect to the current process into the target process when the priority of the target process is higher than that of the current process, and performing the current process when the priority of the target process is lower than that of the current process.

When performing the context switching, the method may further comprise: determining whether or not the current process is entered into the ready queue; and allowing an operating system scheduler to carry out an operation when the current process is entered into the ready queue, and allowing the current process to enter into the ready queue and then allowing the operating system scheduler to carry out the operation when the current process is not entered into the ready queue.

When the priority of the target process is lower than that of the current process, the method comprises: allowing the target process to enter into the ready queue; and finishing the execution of the interrupt handler function and carrying out the operation of the current process.

In still another aspect, there is provided a computer-readable recording medium wherein a program for implementing the method of interrupt scheduling according to the aspects of the present invention.

In the method of interrupt scheduling according to the present invention, the preemption latency caused by the interrupt in the operating system of the computer system can be minimized by omitting the process of allowing the woken-up target process to be entered into the ready queue and the process of selecting a process with the highest priority on the ready queue.

### BRIEF DESCRIPTION OF THE DRAWINGS

The above and other aspects, features and advantages of the disclosed exemplary embodiments will be more apparent from the following detailed description taken in conjunction with the accompanying drawings in which:

FIG. 1 is a flowchart illustrating a conventional method of interrupt scheduling;

FIG. 2 is a flowchart schematically illustrating a method of interrupt scheduling according to a first embodiment of the present invention;

FIGS. 3 and 4 are flowcharts illustrating in detail the method of interrupt scheduling according to the first embodiment of the present invention;

FIG. 5 is a flowchart schematically illustrating a method of interrupt scheduling according to a second embodiment of the present invention; and

FIG. 6 is a flowcharts illustrating in detail the method of interrupt scheduling according to the second embodiment of the present invention.

### DETAILED DESCRIPTION

Hereinafter, a method of interrupt scheduling according to a first exemplary embodiment of the present invention will be described with reference to the accompanying drawings.

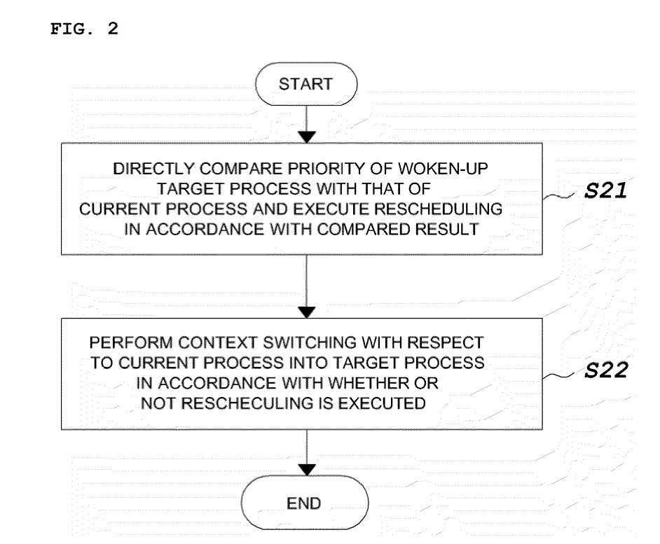

FIG. 2 is a flowchart schematically illustrating a method of interrupt scheduling according to a first embodiment of the present invention.

Referring to FIG. 2, the method of interrupt scheduling according to the first embodiment of the present invention comprises: directly comparing the priority of a target process woken up when an interrupt occurs with that of a current process which is being performed before the occurrence of the interrupt in an operating system of a computer system and executing a rescheduling in accordance with the compared result (S21); and performing direct context switching with respect to the current process into the target process in accordance with whether or not the rescheduling is executed (S22).

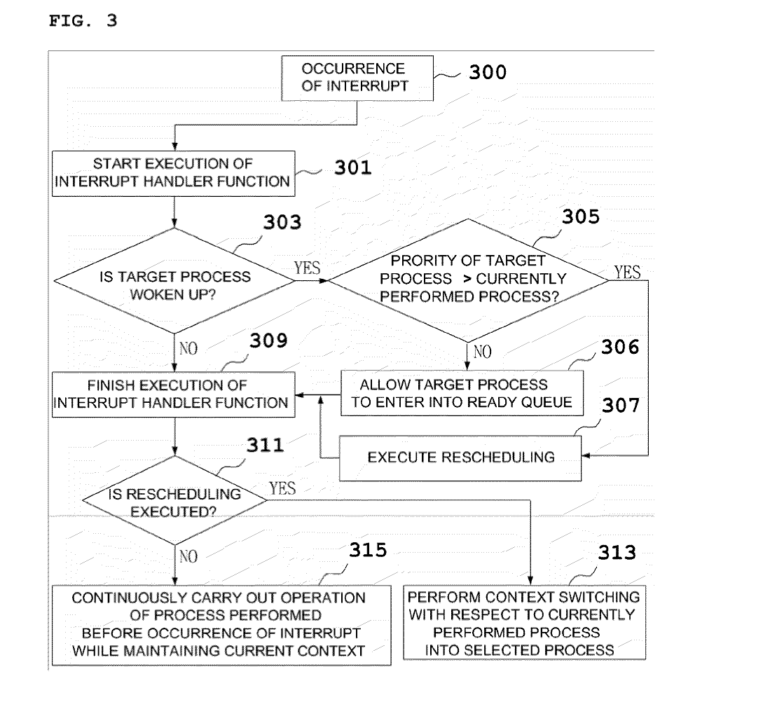

FIG. 3 is a flowchart illustrating in detail the method of interrupt scheduling, illustrated in FIG. 2.

Referring to FIG. 3, when an interrupt occurs in an operating system of a computer system (300), a process which is performed currently is paused, and the execution of an interrupt handler function is started in the context of the current process (301). At this time, the interrupt handler function wakes up a target process in a sleep state while waiting for the corresponding interrupt.

Subsequently, it is determined whether or not the target process is woken up through the interrupt handler function (303). When the target process is woken up, it is compared whether or not the priority of the target process is higher than that of the current process (305). At this time, the priority of the target process is directly compared with that of the current process without allowing the target process to enter into a ready queue.

As a result, when the priority of the target process is higher than that of the current process, a rescheduling is executed (307), which means that the rescheduling is required after the execution of the interrupt handler function is finished. After the rescheduling is executed (307), the execution of the interrupt handler function is finished (309).

On the other hand, when the priority of the target process is lower than that of the current process, the target process is entered into the ready queue, and the execution of the interrupt handler function is finished (309).

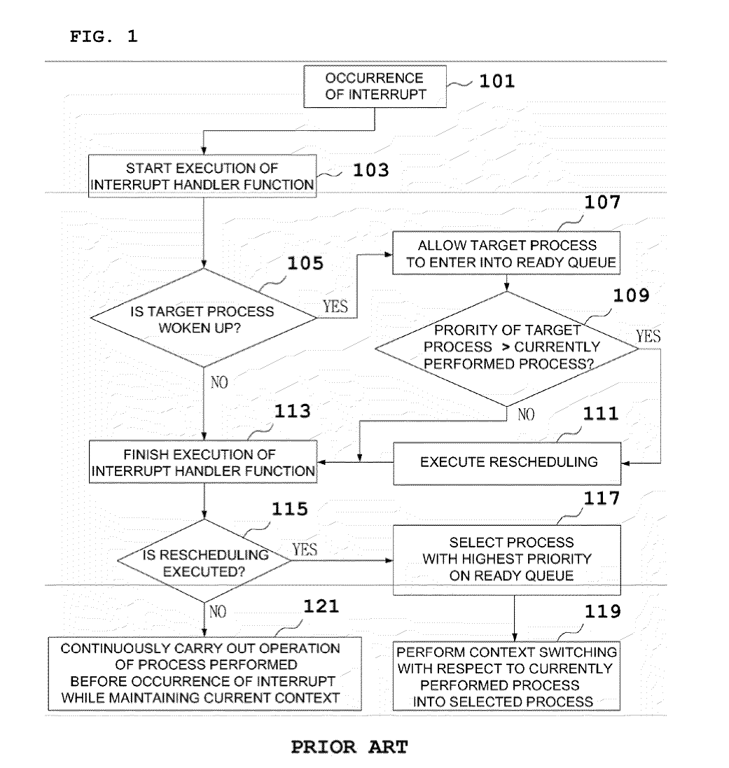

As compared with the conventional method of interrupt scheduling, illustrated in FIG. 1, in the method of interrupt scheduling according to the embodiment of the present invention, the process of allowing the target process woken up by the interrupt handler function to enter into the ready queue is omitted from the occurrence of the interrupt (300) to the execution of the rescheduling (307). When the priority of the target process is higher than that of the current process on the ready queue, it becomes apparent that the target process will preempt the current process. Accordingly, when the execution of the target process is finished, the target process is transferred from the ready queue to a sleep queue. Therefore, it is unnecessary that the target process should be entered into the ready queue.

Subsequently, the execution of the interrupt handler function is finished (309), a kernel checks whether or not the rescheduling is executed (311). When the rescheduling is executed, the context switching of the current process into the target process is immediately performed without the process of selecting the process with the highest priority on the ready queue using an operating system scheduler (313), without selecting a process with the highest priority and performing the context switching with respect to the current process into the selected process by executing an operating system function. On the other hand, when the rescheduling is not executed, the context of the current process is maintained, and the operation of the process performed before the occurrence of the interrupt is continuously carried out (315).

As compared with the conventional method of interrupt scheduling, illustrated in FIG. 1, in the method of interrupt scheduling according to the embodiment of the present invention, when the target process woken up by the occurrence of the interrupt preempts the current process performed before the occurrence of the interrupt, the process of selecting a process with the highest priority on the ready queue using the operating system scheduler and the process of calling the operating system scheduler function to select the process with the highest priority on the ready queue are omitted between the process of finishing the execution of the interrupt handler function and the process of performing context switching with respect to the current process into the target process.

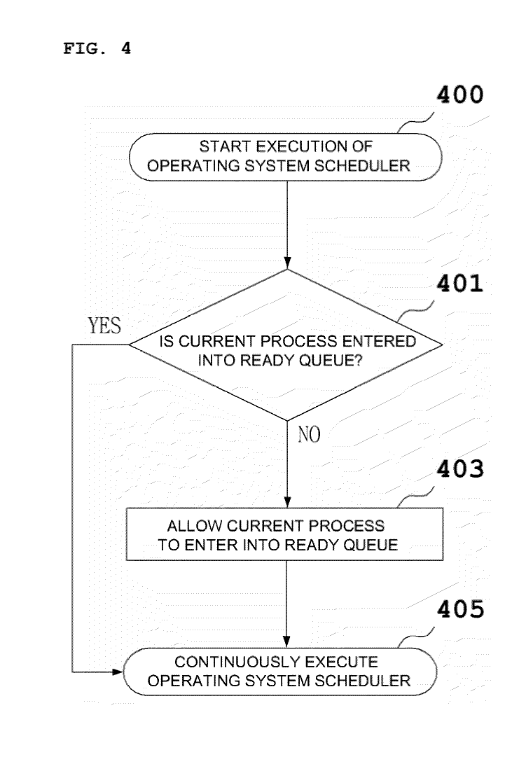

Subsequently, as illustrated in FIG. 4, after the context switching of the current process into the target process is performed, while the target process is running kernel preemption may happen in the state that the current process is not entered into the ready queue. In such a case, the execution of the operating system scheduler is started (400) and after that, it is checked whether or not the current process is entered into the ready queue before the operation of the operating system scheduler function is substantially carried out (401). When the current process is not entered into the ready queue, the current process is entered into the ready queue (403), and the substantial operation of the operating system scheduler is continuously carried out (405). When the current process is entered into the ready queue, the operation of the operating system scheduler is immediately carried out (405).

In the method of interrupt scheduling according to the embodiment of the present invention, the preemption latency caused by the interrupt in the operating system of the computer system can be minimized by omitting the process of allowing the woken-up target process to enter into the ready queue and the process of selecting a process with the highest priority on the ready queue.

That is, when the priority of the target process is higher than that of the current process, the process of allowing the target process to enter into the ready queue is delayed, thereby reducing the preemption latency of the target process. Here, the process of allowing the target process to be entered into the ready queue is a logically unnecessary process in the conventional processes for preemption of the target process. When the priority of the target process is lower than that of the current process, i.e., when there is no process that will be immediately preempted, subsequent processes are performed in accordance with the conventional method, thereby operating an operation system as it is.

Hereinafter, a method of interrupt scheduling according to a second exemplary embodiment of the present invention will be described with reference to the accompanying drawings.

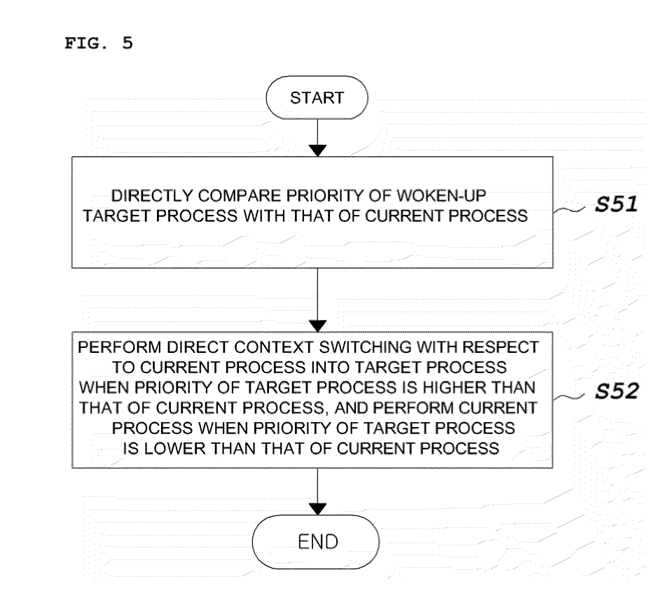

FIG. 5 is a flowchart schematically illustrating a method of interrupt scheduling according to a second embodiment of the present invention.

Referring to FIG. 5, the method of interrupt scheduling according to the second embodiment of the present invention comprises: without allowing a target process woken up when an interrupt occurs to be entered into a ready queue, directly comparing the priority of the woken-up target process with that of a current process performed before the occurrence of the interrupt (S1); and performing direct context switching with respect to the current process into the target process when the priority of the target process is higher than that of the current process, and performing the current process when the priority of the target process is lower than that of the current process (S2).

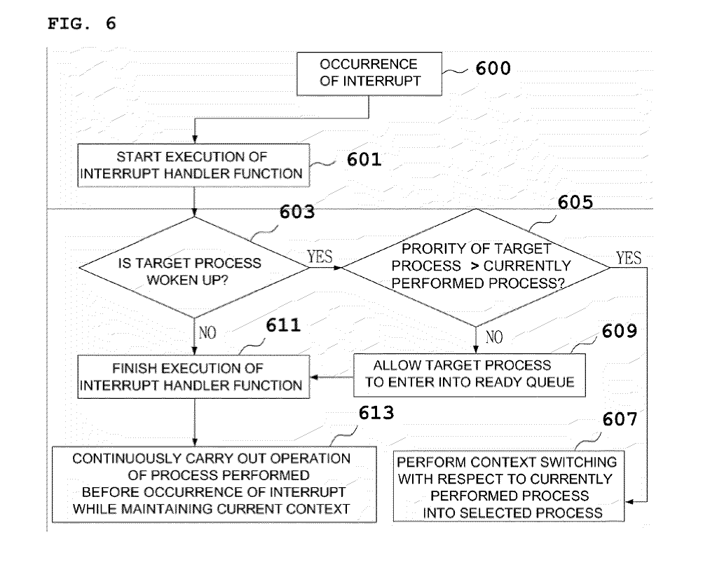

FIG. 6 is a flowchart illustrating in detail the method of interrupt scheduling according to the second embodiment of the present invention.

Referring to FIG. 6, the method of interrupt scheduling according to the second embodiment of the present invention has the following difference from the method of interrupt scheduling according to the first embodiment of the present invention.

In the method of interrupt scheduling according to the first embodiment of the present invention, illustrated in FIG. 3, when the priority of the target process is higher than that of the current process, the rescheduling is executed. However, in the method of interrupt scheduling according to the second embodiment of the present invention, the priority of the target process is compared with that of the current process (605). As a result, when the priority of the target process is higher than that of the current process, the context switching of the current process into the target process is immediately performed without executing the rescheduling (607). Accordingly, the preemption latency of the target process is effectively reduced.

The processes in the method of interrupt scheduling according to the second embodiment of the present invention, except the aforementioned difference, are identical to those in the method of interrupt scheduling according to the first embodiment of the present invention. Therefore, the detailed description of the method of interrupt scheduling according to the second embodiment of the present invention, except the aforementioned difference, will be replaced with that of the method of interrupt scheduling according to the first embodiment of the present invention.

The description of a computer-readable recording medium according to the present invention, in which a program for implementing a method of interrupt scheduling, will be replaced with the detailed description of the method of interrupt scheduling according to the embodiments of the present invention.

While the exemplary embodiments have been shown and described, it will be understood by those skilled in the art that various changes in form and details may be made thereto without departing from the spirit and scope of this disclosure as defined by the appended claims. In addition, many modifications can be made to adapt a particular situation or material to the teachings of this disclosure without departing from the essential scope thereof. Therefore, it is intended that this disclosure not be limited to the particular exemplary embodiments disclosed as the best mode contemplated for carrying out this disclosure, but that this disclosure will include all embodiments falling within the scope of the appended claims.

What is claimed is:

1. A method of interrupt scheduling, comprising:
without allowing a target process woken up when an interrupt occurs to enter into a ready queue, directly comparing the priority of the woken-up target process with that of a current process performed before the occurrence of the interrupt, and executing a rescheduling in accordance with the compared result; and
performing direct context switching with respect to the current process into the target process in accordance with whether or not the rescheduling is executed.

2. The method according to claim 1, after performing the context switching, the method further comprising:
determining whether or not the current process is entered into the ready queue; and
allowing an operating system scheduler to carry out an operation when the current process is entered into the ready queue, and allowing the current process to enter into the ready queue and then allowing the operating system scheduler to carry out the operation when the current process is not entered into the ready queue.

3. The method according to claim 1, wherein the executing of the rescheduling comprises:
determining whether or not the target process is woken up;
directly comparing the priority of the woken-up target process with that of the current process when the target process is woken up; and
executing a rescheduling and then finishing the execution of an interrupt handler function when the priority of the target process is higher than that of the current process, and allowing the target process to enter into the ready queue and then finishing the execution of the interrupt handler function when the priority of the target process is lower than that of the current process.

4. The method according to claim 1, wherein the performing of the context switching comprises:
determining whether or not the rescheduling is executed; and
performing direct context switching with respect to the current process into the target process when the rescheduling is executed, and carrying out the operation of the current process when the rescheduling is not executed.

5. A method of interrupt scheduling, comprising:
without allowing a target process woken up when an interrupt occurs to enter into a ready queue, directly comparing the priority of the woken-up target process with that of a current process performed before the occurrence of the interrupt; and
performing direct context switching with respect to the current process into the target process when the priority of the target process is higher than that of the current process, and performing the current process when the priority of the target process is lower than that of the current process.

6. The method according to claim 5, when performing the context switching, the method further comprising:
determining whether or not the current process is entered into the ready queue; and
allowing an operating system scheduler to carry out an operation when the current process is entered into the ready queue, and allowing the current process to enter into the ready queue and then allowing the operating system scheduler to carry out the operation when the current process is not entered into the ready queue.

7. The method according to claim 5, when the priority of the target process is lower than that of the current process, the method comprises:
allowing the target process to enter into the ready queue; and
finishing the execution of the interrupt handler function and carrying out the operation of the current process.

8. A computer-readable recording medium wherein a program for implementing the method of interrupt scheduling according to any one of claims 1 to 7 is recorded.
